(19) United States
(12) Patent Application Publication
(10) Pub. No.: US 2005/0019241 A1
(43) Pub. Date: Jan. 27, 2005

(54) Preparation of rare earth ceramic garnet

(76) Inventor: Robert Joseph Lyons, Burnt Hills, NY (US)

Correspondence Address: Steven W. Hays;Suite 250, 28333 Telegraph Road, Southfield, MI, 48034, US

(21) Appl. No.: 10/625,440

(22) Filed: Jul. 23, 2003

(51) Int. Cl. C01F 17/00

(52) U.S. Cl. 423/263

(57) ABSTRACT

A rare earth garnet ceramic that may be used as a scintillator element is formed having accurate control of the rare-earth/alumina ratio, thereby increasing the transparency within the elements to a desired ratio. The ceramic is formed by milling together suitable sub-micron rare earth oxide powders and sub-micron alumina powders in a desired ratio. The milled powders are then made into a compact and sintered to form the rare earth garnet ceramic having the desired transparency.

### TECHNICAL FIELD

The present invention relates generally ceramic materials and more specifically to the preparation of rare earth ceramic garnets.

### BACKGROUND ART

In at least some computed tomograph (CT) imaging system configurations, an x-ray source projects a fan-shaped beam which is collimated to lie within an X-Y plane of a Cartesian coordinate system and generally referred to as the “imaging plane”. The x-ray beam passes through the object being imaged, such as a patient. The beam, after being attenuated by the object, impinges upon an array of radiation detectors. The intensity of the attenuated beam radiation received at the detector array is dependent upon the attenuation of the x-ray beam by the object. Each detector element of the array produces a separate electrical signal that is a measurement of the beam attenuation at the detector location. The attenuation measurements from all the detectors are acquired separately to produce a transmission profile.

In known third generation CT systems, the x-ray source and the detector array are rotated with a gantry within the imaging plane and around the object to be imaged so that the angle at which the x-ray beam intersects the object constantly changes. X-ray sources typically include x-ray tubes, which emit the x-ray beam at a focal spot. X-ray detectors typically include a collimator for collimating x-ray beams received at the detector, a scintillator adjacent the collimator, and photodiodes adjacent the scintillator.

Multislice CT systems are used to obtain data for an increased number of slices during a scan. Known multislice systems typically include detectors generally known as three-dimensional (3-D) detectors. With such 3-D detectors, a plurality of detector cells form separate channels arranged in columns and rows.

A scintillator for a 3-D detector may have scintillator elements with dimensions of about 1×2×3 mm, with narrow gaps of about 100 micrometers, i.e., for example, about 0.004 inches, between adjacent elements. As a result of the small size and the close proximity of the elements, fabrication of such elements is difficult. Further, and in use, a signal impinged upon one scintillator element may be improperly reflected upward or to adjacent elements creating crosstalk and loss of resolution. Also, with such small scintillator elements, the magnitude of the generated optical signal may be small, and any losses that occur can significantly deteriorate signal quality.

Therefore, it is very important to form scintillator elements achieving high transparency, high chemical stability, and high-temperature mechanical properties. One scintillator material that achieves these physical characteristics is formed from single crystal rare earth garnets. The preparation and raw material costs associated with the use and formation of scintillator materials from these single crystal rare earth garnets, however, is expensive.

One alternative scintillator material that may be utilized is the so-called rare earth garnet ceramic material. Achieving transparent rare earth garnet ceramics, however, is difficult and requires accurate control of the rare-earth/alumina ratio at 0.6. Slight deviations result in either alumina or perovskite second phase introduces scatter within the ceramic. Slight deviations would require the synthesis a new composition of the ceramic according in the prior art, a time consuming and potentially expensive process.

It is thus highly desirable to derive a method to formulate transparent rare earth garnet ceramics having accurate control of the rare-earth/alumina ratio.

### SUMMARY OF THE INVENTION

The present invention provides a method for forming scintillator elements having accurate control of the rare-earth/alumina ratio, thereby increasing the transparency within the elements to a desired ratio.

The ceramic is formed by milling together suitable sub-micron rare earth oxide powders and sub-micron alumina powders in a desired ratio. The milled powders are then made into a compact and sintered to form the rare earth garnet ceramic having the desired transparency.

The present invention offers advantages over the prior art in that the adjustment of the rare earth/alumina ratio can be made by simply adjusting the blending ratio of the rare earth oxide powders in the alumina rather than synthesizing a new composition as required in the prior art.

Other objects and advantages of the present invention will become apparent upon the following detailed description and appended claims, and upon reference to the accompanying drawings.

### BRIEF DESCRIPTION OF THE DRAWINGS

FIG. 1 is a perspective view of a scintillator having a plurality of scintillator elements;

FIG. 2 is a logic flow diagram for preparing the scintillator of FIG. 1 according to a preferred embodiment of the present invention; and

FIG. 3 is a graph illustrating the emission spectra in an excited and unexcited state of a scintillator wafer made in accordance with the process described in FIG. 2.

### D TAIL D DESCRIPTION OF THE PR FERRED EMBODIM NT

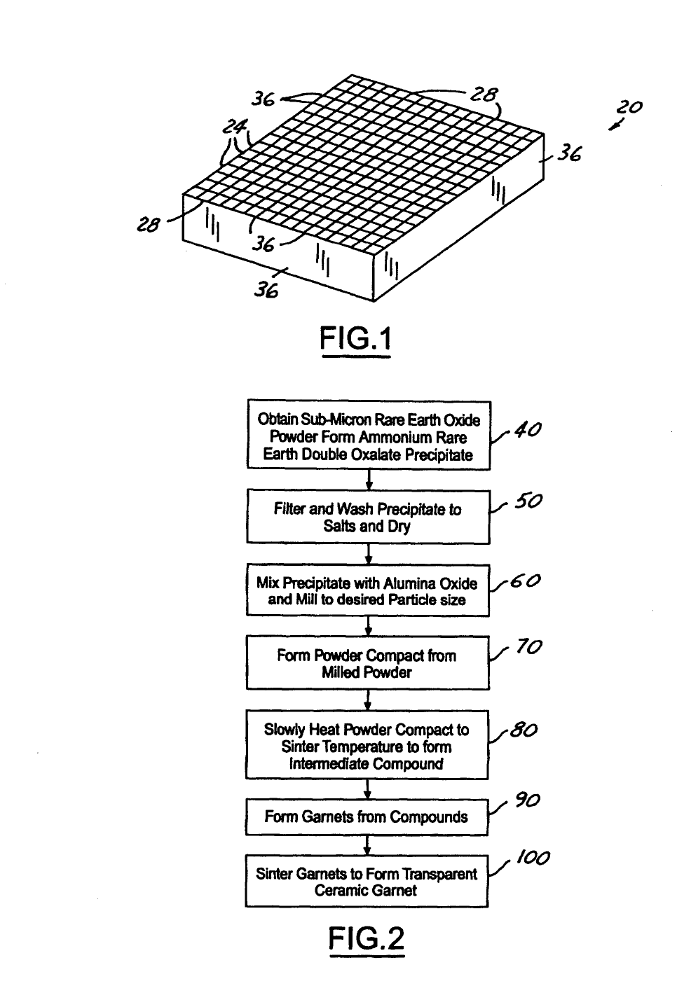

FIG. 1 is a perspective view of a scintillator 20 including a plurality of scintillator elements 24 which are laid out in an array having first gaps 28 and second gaps 32. To increase the spatial resolution and the strength of a signal supplied to a photodiode located adjacent one of scintillator elements 24, gaps 28 and 32 are filled with a reflective material 36. The width of gaps 28 and 32 may range from about 10 to 160 micrometers, i.e., about 0.5 to 6 mils. Reflective material 36 is cast on the adjacent surfaces of elements 24 so that less of the light signal generated by elements 24 is improperly reflected.

The scintillator elements 24 of the present invention are formed of transparent rare earth garnet ceramics that provide an inexpensive, yet equally effective, substitute for single crystal rare earth garnets. The transparent rare earth garnet ceramics that may be formed in the present invention have the formula:
(G_{1-x-y}AₓRe_{y})_{w}D_{z}O₁₂

where G is at least one metal selected from the group consisting of Tb and Lu; A is at least one rare earth metal selected from the group of Y, La, Gd, Lu and Yb when G is Tb; A is at least one rare earth metal selected from the group of Y, La, Gd, Tb and Yb when G is Lu; Re is at least one rare earth metal selected from the group consisting of Ce, Pr, Nd, Sm, Eu, Dy, Ho, Er, and Tm; D is at least one metal selected from the group consisting of Al, Ga, and In; w is a range from about 2.8 up to about and including 3.1%; x is in the range from 0 to about and including 0.5%; y is in the range from 0.0005 to about and including 0.2%; and z is in the range from 4.0 to about and including 5.1%.

The rare earth garnet ceramics of the present invention are required to have a substantially uniform size distribution of the sub micron particles in order to achieve the desired transparency. To achieve this desired transparency for scintillator applications such as shown in FIG. 1; the earth/alumina ratio must be maintained at about 0.6/1. Slight deviations result in either alumina or perovskite second phase, which results in scatter in the ceramic.

FIG. 2 shows a logic flow diagram for forming the transparent rare earth garnet ceramics that can be used in FIG. 1.

Referring now to FIG. 2, and beginning with Step 40, the sub-micron rare earth oxide powder is obtained by adding a aqueous solution of soluble rare earth compounds to a solution of ammonium hydroxide to form a rare earth hydroxide gelatinous precipitate. A solution of oxalic acid is then added to this gelatinous precipitate until a pH of 4 is reached. During this addition, the gelatinous rare earth hydroxide precipitate is converted first to micron sized rare earth oxalate crystals and finally to sub micron particles of ammonium rare earth oxalate. The mechanism and rationale for these reactions are as follows:

The oxalic acid is present as a pH dependent equilibrium of molecular oxalic acid in strongly acidic solutions, binoxalate ions in weakly acidic solutions, and oxalate ions in neutral or basic solutions.
H₂C₂O₄═H⁺+HC₂O₄
HC₂O₄⁻═H⁺+C₂O₄

The introduction of the oxalic acid in turn causes several chemical reactions to take place. First, the oxalic acid neutralizes excess ammonium hydroxide with the hydrogen ions released by the first ionization of oxalic acid.
H⁺⁺ NH₄OH═NH₄⁺+H₂O

The rare earth hydroxide then begins to dissolve as the hydrogen ion concentration increases. For example, where terbium containing ceramic garnets are produced according to the present invention, the reaction may proceed as:
3H⁺+Tb(OH)₃═Tb⁺³+3H₂O

In the basic to neutral solution existing during the early stages of oxalic acid solution introduction, the oxalic acid solution is present primarily as dibasic oxalate ion. This ion reacts with the rare earth ions to form a normal oxalate precipitate.
2Tb⁺³+3C₂O₄⁻²+10H₂O═TB₂(C₂O₄)₃*10H₂O

As the pH increases further, the monobasic binoxalate ion becomes the prevalent species and, together with the ammonium ions in solution, reacts with the original rare earth oxalate precipitate to form a new type of precipitate known as an ammonium rare earth double oxalate precipitate. The conversion of the ammonium rare earth double oxalate precipitate is optimal at a pH of about 4.
Tb₂(C₂O₄)₃*10H₂O+2NH₄⁺+HC₂O₄⁻═2NH₄Tb(C₂O₄)₂+H⁺10H₂O

Next, in Step 50, the formed ammonium rare earth double oxalate precipitate is filtered and washed to salts and dried. The oxalic acid remaining in solution is removed. The washed precipitate is dried without agglomeration by removing the water with organic solvent washes or freeze-drying. The precipitate is then calcined in air at 700 Centigrade to 800 Centigrade to convert it to sub micron rare earth oxide powder.

The present method offers advantages as compared with the standard preparation of rare earth oxalate precipitates by oxalic acid.

For example, the ammonium rare earth double oxalate precipitate forms slowly, as the reaction rate is limited by the reaction of solids, not ions in solution. This allows the solutions to be mixed uniformly throughout the container more quickly than solid-liquid reactions can occur. The solid-liquid reactions are therefore homogeneous, resulting in a more uniform and narrow particle size distribution.

Also, the ammonium rare earth double oxalate precipitates in a preferable size and shape compared to the normal rare earth oxalates for subsequent processing to transparent ceramics.

The commercial availability of sub micron alumina means that only the rare earth oxide component must be synthesized. This results in an approximately 30% reduction in the weight of material that must be synthesized.

The ammonium rare earth double oxalate precipitate is then mixed with an appropriate ratio of aluminum oxide and processed to form a ceramic garnet having the formula (G_{1-x-y}AₓRe_{y})_{w}D_{z}O₁₂. The process is described below in steps 60-110:

In step 60, the rare earth double oxalate precipitate formed in steps 40 and 50 above is mixed with alumina oxide, in the desired ratio, and introduced to a container and milled to a desired particle size using a grinding media. The purpose of the milling is two-fold. First, the milling process thoroughly mixes the two types of particles so that they can fully react with each other in the subsequent sintering process. Also, milling breaks down any large agglomeration of nano particles that would otherwise form a clump of rare earth oxide or alumina in the final product. There is no significant reduction in the size of the nano particles during milling.

The milling can be done in either a wet or dry process depending upon subsequent processing requirements. If dry processing is anticipated, either dry milling or milling in a liquid having a low surface tension is required. This prevents the surface tension of the evaporating droplets between particles to pull the particles into close proximity, thereby forming strong agglomerates. Alcohols or alkanes are usually chosen for milling due to their low surface tension.

If the mixed powder to be cast into a desired shape from a slurry, then water with or without various additives is added to the container for use in the milling process.

As the hardness of the alumina particles can cause considerable wear and tear on the milling equipment, various methods may be used to reduce contamination of the milling media within the milled particles.

For example, the grinding media can be made of yttrium aluminum garnet or another rare earth garnet such as having a similar structure to the rare earth double oxalate precipitate, thus any milling media contamination has no adverse affect on the rare earth garnet product.

Alternatively, alumina oxide media may be used, and additional rare earth oxide could be added to the mixture for the experimentally determined wear of the alumina oxide media.

Further, grinding media can be used which can be removed completely from the resulting powder. For example, Teflon, which can be burned out of the milled powder, may be used as the grinding media. Also, the grinding material could consist of a material that can be sublimed or dissolved from the milled powder.

Next, in Step 70, a powder compact of the milled powders is formed by either pressing the dry powder or drying an aqueous slurry.

In Step 80, the powder compact is slowly heated to the sintering temperature required. During the slow heating, the mixed powders react with each other by solid-state diffusion, first forming a perovskite and other intermediate compounds.

For the purposes of the present invention, a perovskite is defined having a one to one ratio of rare earth to alumina components and has the formula “MA10₃”, where “M” represents the rare earth metal atom. These compounds are rare earth-rich compared to the final (G_{1-x-y}AₓRe_{y})_{w}D_{z}O₁₂ ceramic garnets. Alumina-rich compounds with the formula M₂A1₄O₉ are also formed as intermediate compounds.

These intermediate compounds form and react with one another to form a garnet over the temperature range of 900 to 1100 degrees Celsius in Step 90.

In Step 100, the garnets are sintered at a temperature between approximately 1700 and 1800 degrees Celsius to form a ceramic garnet having the formula (G_{1-x-y}AₓRe_{y})_{w}D_{z}O₁₂ as described above The sintering atmosphere is preferably oxygen, vacuum, or wet hydrogen gas.

If vacuum or wet hydrogen gas is utilized, some oxygen deficiency of the garnet is realized. The oxygen deficient garnets are then oxidized by exposure to oxygen gas at above 1000 degrees Celsius. The higher the temperature, the faster the oxygen diffuses into the reduced garnet, thereby replacing missing oxygen atoms in the garnet.

During the process of garnet formation, rare-earth garnet-alumina oxide eutectic compositions may be formed that melt several hundred degrees lower than the ceramic garnet itself. This has the effect of dispersing any local excesses of alumina by melting these areas. The liquid travels through porosity and grain boundaries into areas rich in rare earth oxides. The liquid/solid reactions play a key role in achieving high-density phase pure ceramic garnets. The rare earth garnet/alumina eutectics melt in the range of about 1600-1700 degrees Celsius. The garnets melt between about 1800-2000 degrees Celsius, while sintering is performed at approximately 1700 to 1800 degrees Celsius.

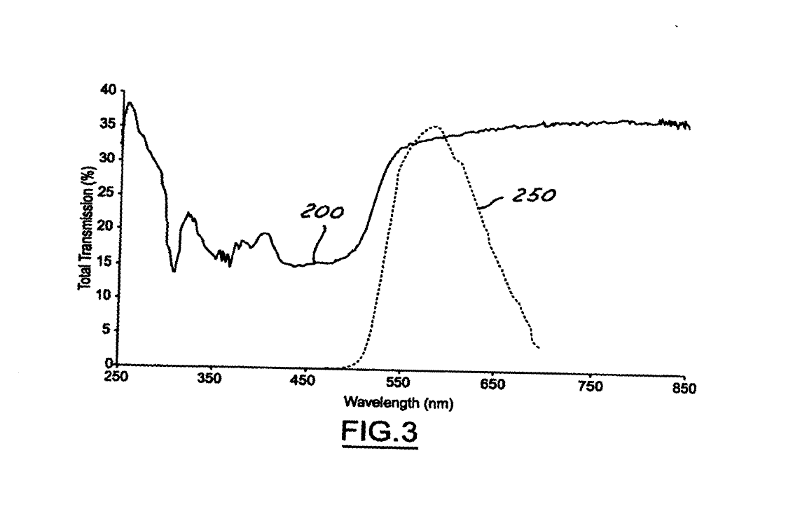

Referring now to FIG. 3, a terbium-lutetium aluminum garnet wafer having a thickness of about 1.77 millimeters made in accordance with the process described above in FIG. 2 is measured for total percent transmission of light at various wavelengths with (plot 200) and without (plot 250) x-ray excitation excitation. FIG. 3 indicates that the percentage of light absorbed from the x-ray excited state was minimal between about 500 nanometers and 700 nanometers. FIG. 3 also illustrates that the emission of light, from the x-ray excited state, between approximately 500 and 700 nanometers, was measured as bell-shaped curve with the peak wavelength of about 600 nanometers. The readings achieved in FIG. 3 are consistent with a wafer having uniform particle distribution and transmission in the desired wavelengths typically used in x-ray applications.

The present invention offers advantages over the prior art in that the adjustment of the rare earth/alumina ratio can be made by simply adjusting the blending ratio of the rare earth oxide powders in the alumina rather than synthesizing a new composition as required in the prior art.

The present invention also reduces the amount of material that requires synthesis to those materials commercially unavailable as sub micron powders.

While one particular embodiment of the invention have been shown and described, numerous variations and alternative embodiments will occur to those skilled in the art. Accordingly, it is intended that the invention be limited only in terms of the appended claims.

1. A method for forming a transparent rare earth garnet ceramic having a precise earth-alumina ratio and having the chemical composition (G_{1-x-y}AₓRe_{y})_{w}D_{z}O₁₂, where G is at least one metal selected from the group consisting of Tb and Lu; A is at least one rare earth metal selected from the group of Y, La, Gd, Lu and Yb when G is Tb; A is at least one rare earth metal selected from the group of Y, La, Gd, Tb and Yb when G is Lu; Re is at least one rare earth metal selected from the group consisting of Ce, Pr, Nd, Sm, Eu, Dy, Ho, Er, and Tm; D is at least one metal selected from the group consisting of Al, Ga, and In; w is a range from about 2.8 up to about and including 3.1%; x is in the range from 0 to about and including 0.5%; y is in the range from 0.0005 to about and including 0.2%; and z is in the range from 4.0 to about and including 5; the method comprising:
forming an ammonium rare earth double oxalate precipitate;
washing and drying said ammonium rare earth double oxalate precipitate;
calcining said ammonium rare earth double oxalate precipitate;
mixing a first quantity of said ammonium rare earth double oxalate precipitate with a second quantity of aluminum oxide to form a mixture having the precise earth-alumina ratio;
milling said mixture to a desired particle size;
compacting said milled mixture to form a powder compact;
sintering said powder compact to form a perovskite and other intermediate compounds;
heating said perovskite and other intermediate compounds at between 900 and 1100 degrees Celsius to form a garnet; and
sintering said garnet at a temperature between approximately 1700 and 1800 degrees Celsius.

2. The method of claim 1, wherein forming a ammonium rare earth double oxalate precipitate comprises:
introducing an aqueous solution of soluble rare earth compounds to an ammonium hydroxide solution to form a rare earth hydroxide gelatinous precipitate; and
reducing the pH of said rare earth oxide gelatinous precipitate to about 4.0 by introducing a first amount of oxalic acid solution to said rare earth hydroxide gelatinous precipitate.

3. The method of claim 1, wherein calcining said rare earth oxide precipitate comprises calcining said rare earth oxide precipitate at between approximately 700 and 800 degrees Celsius.

4. The method of claim 1, wherein milling said mixture comprising dry milling said mixture to a desired particle size.

5. The method of claim 1, wherein milling said mixture comprises:
introducing a low surface tension liquid to said mixture; and
wet milling said mixture to a desired particle size.

6. The method of claim 5, wherein said low surface tension liquid comprises a low surface tension alkane.

7. The method of claim 5, wherein said low surface tension liquid comprises a low surface tension alcohol.

8. The method of claim 1, wherein compacting said milled mixture comprises dry pressing said milled mixture to form a powder compact.

9. The method of claim 1, wherein sintering said garnet comprises:
sintering said garnet comprises sintering said garnet at between approximately 1700 and 1800 degrees Celsius in an oxygen atmosphere.

10. The method of claim 1, wherein sintering said garnet comprises:
sintering said garnet comprises sintering said garnet at between approximately 1700 and 1800 degrees Celsius in a vacuum to form the transparent rare earth garnet ceramic and an oxygen deficient garnet; and
introducing said oxygen deficient garnet to an oxygen atmosphere above 1000 degrees Celsius to form an additional amount of the transparent rare earth garnet ceramic.

11. The method of claim 1, wherein sintering said garnet comprises:
sintering said garnet comprises sintering said garnet at between approximately 1700 and 1800 degrees Celsius in a wet hydrogen gas atmosphere to form an oxygen deficient transparent rare earth garnet ceramic; and
introducing said oxygen deficient garnet to an oxygen atmosphere above 1000 degrees Celsius to form an additional amount of the transparent rare earth garnet ceramic.

12. The method of claim 1, wherein the earth-alumina ratio of the transparent rare earth garnet ceramic is approximately 0.6/1.

13. The method of claim 4, wherein milling said mixture comprising dry milling said mixture with a rare earth garnet grinding media to a desired particle size.

14. The method of claim 4, wherein said rare earth garnet grinding media comprises yttrium aluminum garnet.

15. The method of claim 4, wherein milling said mixture comprising dry milling said mixture with an alumina oxide grinding media to a desired particle size.

16. The method of claim 15, wherein a third quantity of said ammonium rare earth double oxalate precipitate is added to said mixture to maintain the precise earth-alumina ratio, said third quantity being a function of the predetermined wear characteristics of said alumina oxide grinding media during said milling of said mixture.

17. The method of claim 4, wherein milling said mixture comprises
dry milling said mixture with a grinding media to a desired particle size; and
removing said grinding media from said milled mixture prior to compacting said milled mixture.

18. The method of claim 17, wherein removing said grinding media comprises burning said grinding media out of said milled mixture prior to compacting said milled mixture.

19. The method of claim 17, wherein removing said grinding media comprises subliming said grinding media out of said milled mixture prior to compacting said milled mixture.

20. The method of claim 17, wherein removing said grinding media comprises dissolving said grinding media out of said milled mixture prior to compacting said milled mixture.
